(19) United States
(12) Patent Application Publication
(10) Pub. No.: US 2026/0168817 A1
(43) Pub. Date: Jun. 18, 2026

(54) METHOD FOR THE ITERATIVE CORRECTION OF DIGITAL MAPS

(71) Applicant: Robert Bosch GmbH, Stuttgart (DE)

(72) Inventors: Jan Rohde, Dettingen Unter Teck (DE); Max Kirstein, Hohenhameln - Ot Bruendeln (DE); Peter Engel, Hessisch Oldendorf (DE); Thomas Wenzel, Hamburg (DE)

(21) Appl. No.: 19/409,107

(22) Filed: Dec. 4, 2025

(30) Foreign Application Priority Data
Dec. 18, 2024 (DE) 10 2024 138 668.1

(51) Int. Cl. G01C 21/00; G01C 21/32; G06N 3/08

(52) U.S. Cl. CPC G01C 21/3841; G01C 21/32; G01C 21/3815; G01C 21/387; G01C 21/3896; G06N 3/08

(57) ABSTRACT

A computer-implemented method for correction of digital maps, in particular for vehicle navigation. The method includes: using existing sensor data, i.e., from vehicles, which were acquired using an acquisition unit, creating a digital map by combining the sensor data with existing map data; iteratively training a machine AI model based on the initial digital map and the sensor data; applying the trained AI model to identify deviations between the digital map and the actual conditions of the environment of at least one vehicle; suggesting corrections of the identified deviations in the digital map based on the results of the machine AI model and displaying these suggestions for review by a human user and/or the trained AI model; wherein the correction of the digital map is carried out by a manual check by the user, and/or the correction of the digital map is carried out automatically using the AI model.

### CROSS REFERENCE

The present application claims the benefit under 35 U.S.C. § 119 of Germany Patent Application No. DE 10 2024 138 668.1 filed on Dec. 18, 2024, which is expressly incorporated herein by reference in its entirety.

### FIELD

The related art comprises several methods for the correction and correction of digital maps for vehicle navigation. These maps, in particular high-definition (HD) maps, are essential for autonomous driving because they contain precise information about road infrastructures such as lane markings and traffic signs.

Germany Patent Application No. DE 10 2021 000 519 A1 describes a method for validating map object relationships and attributes for a digital map, comprising the steps of:-acquiring environmental data using an acquisition device of a vehicle,-comparing the ascertained environmental data with corresponding data from the digital map,-verifying the validity of the digital map if the ascertained environmental data correspond to the data of the digital map to a defined extent, wherein a reference map is created on the basis of vehicle data and acquired environmental data, wherein an initial ascertainment of attributes and object relationships of the map elements is performed, wherein a machine learning method is trained on the reference map, wherein the machine learning method is trained with data from the reference map in order to estimate the attributes and relationships of the reference map, wherein the machine learning method is applied to a new or modified map in order to estimate the attributes and object relationships using the data of the new or modified map.

An object of the present invention is to provide a method and a system that automates and optimizes the correction and correction of digital maps for vehicle navigation.

### SUMMARY

The present invention relates to a method and a system for the correction of digital maps, in particular for vehicle navigation. Sensor data, in particular from vehicles, are used here to create a digital map. According to an example embodiment of the present invention, a machine AI model is trained on the basis of these sensor data and the map in order to identify deviations between the map and the real environment and to suggest appropriate corrections. These corrections are made either manually by a user or automatically by the AI model.

The method of the present invention is therefore suitable for the iterative correction and improvement of high-resolution maps, in particular for vehicle navigation, and is based on a machine learning model. Unlike conventional methods, this method explicitly requires a ground truth reference for training the model, i.e., a complete labeling of the cartographic data that contains the precise distinction between correct and incorrect map elements. This makes it possible for the model to accurately locate and detect sources of error in order to automatically identify errors later in newly created, initial maps. The training process of the AI model comprises an initial correction iteration, which is carried out by human annotators or suggestions. This manual verification serves as the initial ground truth and becomes the training basis for the machine learning model. This method gives the model the ability to independently identify potential deviations and errors in further maps and to provide specific suggestions for improvement.

Iterative correction therefore describes a repeating process in which gradual adjustments are made in order to achieve a continuous improvement or optimization. Each correction step builds on the results of the previous step so that inaccuracies and deviations are gradually minimized. When applied to digital maps for vehicle navigation, this means that sensor data are first collected and compared with the existing map information in order to identify errors or discrepancies. On the basis of these deviations, the maps are adjusted, either automatically by algorithms or manually by users. The corrected maps are then validated by comparing them again with reality in order to check that the changes made have resolved the identified problems. This process is repeated until an acceptable accuracy of the maps is achieved.

In this context, sensor data refers to any data that are acquired by sensors, in particular sensors of vehicles, and can be used for creating and correcting the digital map. These data can originate from various sensors, such as cameras, lidar, radar and GPS, and are collected continuously or at fixed intervals.

The digital map is created from the received sensor data and can integrate existing map data to ensure an accurate representation of the environment. This map forms the basis for the further correction process.

The machine AI (artificial intelligence) model is a computer-based learning system that has neural networks, and, by analyzing the sensor data, detects deviations between the initial map and the actual environment. Through continuous training, the model can respond to new sensor data and over time improve the accuracy of map correction.

The correction process is carried out by the machine AI model, which analyzes the detected deviations and generates corresponding suggestions for correcting the map. These corrections are either checked manually by a user, for example using a graphical user interface, or automatically carried out by the AI model responsible for automatic correction of the map.

One advantage of the method of the present invention is that the correction of the map is carried out iteratively. The machine AI model learns from each iteration step, which results in a continuous improvement in the correction suggestions by the user and/or by the AI model, and thus to a more accurate map. This reduces manual effort while increasing correction accuracy.

The method combines sensor data, which can advantageously be collected continuously and in real time from a fleet of vehicles or systems, with existing map data to initially create digital maps. A machine AI model, which is specifically trained to detect road features such as line markings and traffic signs, is updated iteratively in order to learn from new sensor data and to improve the accuracy of the correction processes.

The core of the method of the present invention is the identification of deviations between the initial digital map and the actual conditions of the environment, in particular of a vehicle. These deviations are analyzed by the machine AI model, which generates specific correction suggestions. These suggestions can either be manually checked and confirmed by a user or be automatically integrated into the digital map by the AI model. The corrections are stored in a central database, as a result of which the updated maps are made available for further analyses and correction processes.

According to an example embodiment of the present invention, the method integrates a large amount of sensor data, including lidar, radar, camera images and GPS data, in order to make a comprehensive correction of the digital map possible. Additionally, an iterative feedback mechanism is implemented, in which the results of the AI model are continuously evaluated and, if necessary, used for retraining. This allows a continuous optimization of the corrections until a predefined accuracy of the map is achieved. The corrections can also be adjusted on the basis of individual driving patterns and driving habits of the vehicles in the fleet in order to further increase the relevance and precision of the maps.

The present invention makes it possible to verify and correct maps so that they meet the requirements of vehicle navigation, in particular for autonomous vehicles. These maps serve not only for localization but also as a basis for navigation and control of the vehicles. In addition, the corrected maps can be provided in real time to support adaptive navigation solutions.

The method of the present invention can be used not only for vehicles but also for computer-controlled systems, such as robot systems, household appliances, power tools, manufacturing machines, personal assistants or access control systems. These systems benefit from high-resolution maps because they can optimize control and navigation on the basis of the verified maps for the systems. For vehicles, this means, for example, that navigation and driving decisions can be made on the basis of precise road data, while robot systems can use the maps to detect obstacles and adjust their movements accordingly.

Furthermore, the maps can serve as an information basis for information transmission systems, such as surveillance systems or medical imaging systems. In a surveillance system, for example, the maps could help to precisely identify movement patterns or critical areas, while in medical imaging systems, maps could provide similar information to support diagnostic processes.

Advantageously, sensor data collection can be carried out continuously and in real time, in particular from a fleet of vehicles. This makes possible a timely adjustment of the maps to the current road conditions.

Sensor data collection in this context means the continuous acquisition of environmental data, in particular through the sensors installed in the vehicles. A fleet of vehicles refers to a group of multiple vehicles, whose sensor data are used together for correction.

Through the iterative suggestions of the user and/or of the AI model this creates a more comprehensive and up-to-date data basis for map correction, which increases the accuracy of the corrections.

Advantageously, according to an example embodiment of the resent invention, the machine AI model can comprise a neural network that is trained specifically to detect road features, such as line markings.

A neural network is an AI system that is trained to detect patterns in the data and make predictions or decisions on the basis of those patterns.

This makes a precise identification of relevant road features possible, which significantly improves the quality of the map data.

Advantageously, according to an example embodiment of the resent invention, the machine AI model can be continuously updated to learn from new sensor data and improve the accuracy of map correction.

Continuous learning refers to the ability of the model to gain knowledge from constantly new data and to adapt accordingly so that the accuracy of the correction is thereby improved.

As a result, the method of the present invention becomes more flexible and can dynamically adapt to changed road conditions or new traffic information.

Advantageously, the digital map can comprise different layers, such as a landmark layer containing lane markings and traffic signs, and a planning layer that maps lane topologies. These layers are each verified and corrected separately using specialized AI models.

A landmark layer comprises prominent objects of the road infrastructure that are important for navigation, such as lane markings, traffic signs, or traffic control devices. The planning layer contains information about the structure and arrangement of the lanes and their connections.

This allows a specialized and more precise correction of the different layers by the separately trained AI models, resulting in an overall higher accuracy of the digital map.

Advantageously, according to an example embodiment of the present invention, the correction process can be based on a comparison between a current 3D environment map and the initial digital map.

A 3D environment map is a three-dimensional representation of the real environment, created using various sensor data such as lidar or camera data.

The correction of the digital map is thereby adapted to the actual conditions of the environment.

Advantageously, according to an example embodiment of the present invention, the machine AI model can identify error classes and generate specific correction suggestions for each class.

Error classes comprise specific types of deviations in the digital map, such as positional errors, missing objects, or incorrect attributions.

Positional errors refer to deviations in the digital map in which the actual position of road features, such as lanes, traffic signs or infrastructure, differs from the position shown on the map. These errors can occur locally (individual objects) or globally (entire sections) and impair navigation, since the recorded positions do not correspond to the real conditions.

Missing objects are deviations in which relevant road features or infrastructure objects, such as traffic signs, road markings or landmarks, are not present in the digital map even though they exist in the real environment. This can significantly reduce the accuracy of the maps and lead to problems with vehicle navigation.

Incorrect attributions refer to errors in which the properties or classifications of objects in the digital map are incorrect. Examples of this include incorrect information about traffic rules (e.g. speed limits), incorrect labeling of lanes, inaccurate descriptions of road conditions, or incorrect identification of objects, such as traffic lights instead of traffic signs. Such errors can make it difficult for navigation systems to correctly interpret the map and can lead to incorrect route decisions.

The correction process thereby becomes more efficient, since the errors can be systematically analyzed and specifically addressed.

Advantageously, according to an example embodiment of the present invention, the corrections to the digital map can be automatically transmitted to a central database to make them available for further analyses and corrections.

A central database is a storage location where all verified and corrected map data are collected and stored so as to be retrievable by other processes or systems.

This ensures efficient storage and distribution of the corrected maps, so that the updated data can be made available for further corrections or applications.

Advantageously, the correction of the digital map can be supported by comparing real-time data with existing historical data from a plurality of sources.

Historical data refers to previously collected and verified sensor data or map data. These data can be used as a reference for correcting current map data.

The accuracy of the corrections is thereby increased, since comparisons with established data make it easier to detect deviations and thus allow a more precise correction.

Advantageously, according to an example embodiment of the present invention, an iterative feedback mechanism can be implemented which evaluates the correction suggestions of the machine AI model and retrains the model if necessary.

A feedback mechanism here means the possibility of generating new training data after each iteration of the correction, which further improve the machine AI model. This is done by evaluating the corrections, either manually by the user or automatically by the AI model.

This makes a continuous improvement of the AI model possible, resulting in increasingly precise maps and corrections.

Advantageously, according to an example embodiment of the present invention, the machine AI model can combine different types of sensor data, including lidar, radar, satellite, camera and GPS data, to make a comprehensive correction of the maps possible.

Sensor data comprise a large amount of acquired information originating from different sources, such as lidar (light detection and ranging), radar, or satellite images, which are used for navigation and correction of the digital map.

A more precise and comprehensive correction is thereby achieved, since different sensor data are combined to provide a more complete picture of the environment.

Advantageously, according to an example embodiment of the present invention, during the correction process the map can be made available to autonomous vehicles which adjust their navigation and/or control on the basis of the verified map.

Autonomous vehicles are vehicles that can navigate without human intervention on the basis of sensor data and digital maps. These vehicles use the verified and corrected map data to adjust their control.

The driving safety and efficiency of the autonomous vehicles is thereby improved, since they can rely on constantly updated and verified maps.

Advantageously, according to an example embodiment of the present invention, the corrections to the map can be optimized on the basis of the individual driving patterns and driving habits of the vehicles in the fleet.

Driving patterns refer to typical behaviors or routes that have been acquired by a vehicle or group of vehicles over an extended period of time. This information can be used to adapt the map correction to specific needs.

The map is thereby tailored to the characteristics of the vehicles used, which further improves the precision of the corrections and driving performance.

Advantageously, according to an example embodiment of the present invention, the correction of the digital map can be repeated iteratively until a predefined accuracy of at most a 0.01% deviation of the corrected map from the initial map is achieved.

A deviation refers to the difference between the map corrected by the AI model and the actual conditions of the environment, measured in percent. An accuracy value of at most 0.01% means a relatively small deviation from the real 3D map of the environment.

This ensures that the map has only minimal errors, thereby significantly increasing navigation safety.

Another aspect of the present invention is a system for the iterative correction of digital maps for vehicle navigation. According to an example embodiment of the present invention, the system comprises a processing and training unit for creating and continuously updating a machine AI model, a correction unit for applying the machine AI model to the digital map in order to identify and correct deviations, and a storage unit for centrally storing the verified and corrected digital maps.

The processing and training unit is a system component that is responsible for processing the collected sensor data. This unit creates a machine AI model that is trained on the basis of the sensor data. The model is continuously updated in order to integrate new sensor data and to increase the accuracy of the correction and correction of the digital maps.

The correction unit is responsible for applying the machine AI model to the digital map. On the basis of the sensor data it identifies deviations between the digital map and actual conditions. On the basis of these deviations, correction suggestions are generated and incorporated into the digital map either manually or automatically.

The storage unit stores the verified and corrected digital maps centrally, making them available for future corrections and analyses. Central storage makes it possible for the corrected map data to be used for various applications, such as the navigation of autonomous vehicles.

One advantage of this system lies in the continuous improvement of map correction. Thanks to the iterative application of the AI model and the integration of new sensor data, the accuracy of the maps is continuously optimized while manual effort is reduced.

The system of the present invention can advantageously also comprise an acquisition unit. The acquisition unit refers to a system component that can acquire sensor data from vehicles in real time or at specified times. These sensor data typically comprise information from lidar, radar, satellite, camera and GPS sensors that map the environment of the vehicles.

### BRIEF DESCRIPTION OF THE DRAWING

The present invention is explained with reference to the figure.

FIG. 1 is a schematic representation of the iterative correction process of digital maps for vehicle navigation, according to an example embodiment of the present invention.

### DETAILED DESCRIPTION OF EXAMPLE EMBODIMENTS

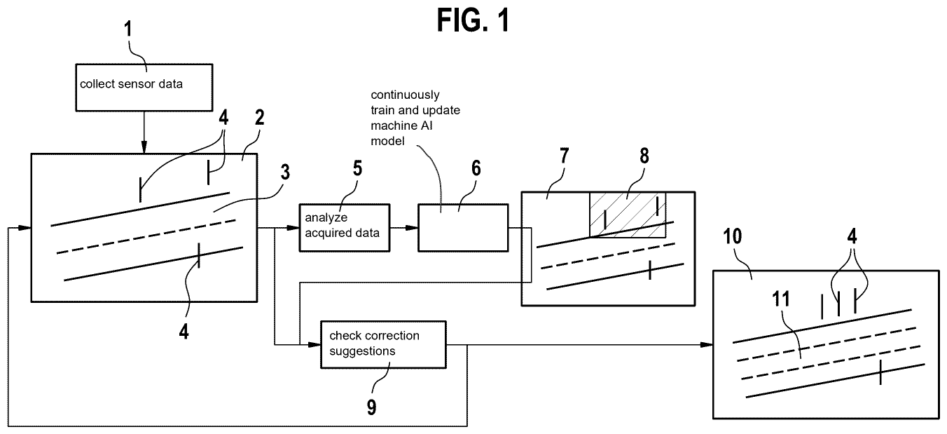

FIG. 1 shows a schematic representation of the iterative correction process of digital maps for vehicle navigation, as used in the described method. FIG. 1 illustrates the sequence of the sensor data collection, the processing by a machine AI model, the identification of error classes, and the correction of the digital map by means of manual or automatic interventions.

In the first step 1, sensor data are collected from a fleet of vehicles using the acquisition unit. These sensor data can comprise lidar, radar, camera, GPS and satellite data, which are acquired in real time or at defined intervals. These data are incorporated into the correction process 2 of the digital map 3 with multiple landmarks 4, such as lane markings and traffic signs, wherein the verification process 2 is carried out by means of a processing and training unit.

The acquisition unit is responsible for collecting these sensor data and transmits them to the processing and training unit.

In a further method step 5, an analysis of the acquired data is carried out using a feature tensor. A feature tensor is a multidimensional data structure used in machine data processing, in particular in the fields of machine learning and image processing. It is used to represent complex features of an input, which features can consist of multiple dimensions, for example in the form of images, videos or sensor data.

In map correction, a feature tensor would store the extracted features of the sensor data (such as lidar, radar or camera images) in a structured form so that these features can be processed and analyzed by the machine learning model. The feature tensor could contain information such as position, shape, and other properties of the detected objects.

The function of a feature tensor is to organize the essential features of the input data such that they can be processed efficiently by the model. It serves as the basis for decision-making in the model by structuring the relevant information in a way that the machine learning model uses to detect patterns and identify deviations. In a map correction process, a feature tensor could be used, for example, to represent different objects in the environment, such as lanes or traffic signs, and to compare them with the corresponding objects in the digital map.

In the next step, step 6, a machine AI model is continuously trained and updated. This model is specialized in detecting deviations between the created initial digital map 3 and the actual conditions of the environment, which are acquired by means of the acquisition unit.

The machine AI model analyzes the sensor data and identifies different error classes: positional errors, where objects such as lanes or traffic signs are not correctly placed on the map; missing objects, where features such as traffic signs or road markings exist in reality but are missing from the map; incorrect attributions, where there are errors in the properties of objects, such as incorrect information about traffic rules or road conditions.

In the next step 7, the AI model generates correction suggestions 8, which are either checked manually by a user via a graphical user interface in a further step 9 or corrected automatically by the AI model 6. These corrections are then iteratively incorporated into the digital map 3. The crucial step 7 of this method is therefore the creation of a ground truth through the correction suggestions 8 by the user or by the AI model in the first iteration. In this first iteration, the correction can only be made by human users or annotators who identify and label specific errors in the map data. These manually created correction annotations serve as the initial ground truth and form the basis for training the machine AI model. In subsequent iterations, the AI model is further trained with the accumulated correction annotations from all previous iterations. As a result, the model can gain in accuracy at each step and increasingly independently detect and correct errors in new map versions. This iterative approach makes possible a continuous improvement of the AI model by expanding and refining the ground truth with each iteration. The method thus creates a learning environment in which correction accuracy improves over time and the efficiency of map correction increases.

The correction process is iterative: The verified and corrected map 3 is fed back into the training of the machine AI model in step 6, which is continuously updated on the basis of the new data. After each iteration, the accuracy of the digital map is improved by reducing the deviations and making the correction suggestions 8 more precise.

At the end of the correction process, after an accuracy threshold of, for example, less than 0.01% deviation is reached, the verified and corrected maps are stored in the storage unit in a further step 10. This central database contains the updated maps 11, which are available for future navigation and further corrections.

The results of the machine AI model can change with each iteration, since the model is based on new sensor data and through continuous training learns to identify deviations more accurately and suggest the corrections more precisely.

FIG. 2 shows a schematic representation of an embodiment of a system for the iterative correction of digital maps for vehicle navigation, consisting of three central units.

The training unit 20 is responsible for creating and continuously updating a machine AI model. Sensor data from the vehicle fleet are used for this, which are regularly processed and combined with the existing map data. The processing and training unit trains the AI model to detect patterns in the data and to identify potential deviations in the digital maps.

The correction unit 21 receives the trained AI model from the processing and training unit and applies it to digital maps. The goal is to identify deviations between the digital map and the actual conditions of the environment of a vehicle and to generate correction suggestions. The correction unit integrates the results of the AI model and ensures that the suggestions can either be checked manually by a user or implemented automatically.

The storage unit 22 serves for the central storage of the verified and corrected digital maps. It ensures that the updated maps are available for subsequent analyses and corrections. Furthermore, the storage unit functions as a database that archives the results of the iterative correction process and serves as a basis for the continuous improvement of the maps.

The arrow connections between the boxes illustrate the flow of information between the units. The processing and training unit 20 delivers the trained AI model to the correction unit 21, which then forwards the corrected maps to the storage unit 22. The stored maps can in turn be used as a basis for further training cycles, which underlines the iterative nature of the system.

What is claimed is:

1. A computer-implemented method for correction of digital maps for vehicle navigation, the method comprising the following steps:
creating, using sensor data from vehicles acquired using an acquisition unit, an initial digital map by combining the sensor data with existing map data;
iteratively training a machine AI model based on the initial digital map and the sensor data;
applying the trained AI model to identify deviations between the initial digital map and actual conditions of an environment of at least one vehicle;
suggesting a correction of the identified deviations in the initial digital map based on results of the machine AI model, and displaying the suggestion for review by a human user and/or the trained AI model; and
carrying out the correction of the initial digital map by a manual check by the user, and/or automatically using the AI model.

2. The method according to claim 1, wherein the sensor data are collected continuously and in real time from a fleet of vehicles and processed.

3. The method according to claim 1, wherein the machine AI model includes a neural network that is trained specifically to detect road features.

4. The method according to claim 3, wherein the road features include lane markings.

5. The method according to claim 1, wherein the machine AI model is continuously updated to learn from new sensor data and improve accuracy of the correction.

6. The method according to claim 1, wherein the digital map includes a landmark layer and/or an infrastructure feature layer which includes infrastructure objects and/or a planning layer, which are verified and corrected independently of one another using separately trained AI models.

7. The method according to claim 6, wherein the landmark layer includes lane markings and traffic signs, and the planning layer includes lane topologies.

8. The method according to claim 1, wherein the correction of the initial digital map is based on a comparison between a current 3D environment map and the initial digital map.

9. The method according to claim 1, wherein the machine AI model is used to identify error classes and to generate specific correction suggestions for each class.

10. The method according to claim 1, wherein the correction in the initial digital map is automatically transmitted to a central database and made available for further analyses and correction.

11. The method according to claim 1, wherein the correction of the initial digital map is supported by comparing real-time data with existing historical data from a plurality of sources.

12. The method according to claim 1, wherein an iterative feedback mechanism is implemented, which evaluates the correction suggestion of the machine AI model and retrains the machine AI model when necessary.

13. The method according to claim 1, wherein the machine AI model combines different types of sensor data to make possible comprehensive correction of the digital map, the different types of sensor data including lidar data and radar and satellite and camera and GPS data.

14. The method according to claim 1, wherein the initial digital map is made available during the correction of the initial digital map to autonomous vehicles, which adjust their navigation and/or control based on a verified map.

15. The method according to claim 1, wherein the correction to the initial digital map is optimized based on individual driving patterns and driving habits of the vehicles in the fleet.

16. The method according to claim 1, wherein the correction of the initial digital map is iteratively repeated until a prespecified accuracy of at most 0.01% deviation from the initial digital map is achieved.

17. A system for iterative correction of digital maps for vehicle navigation, comprising:
a processing and training unit configured to create and continuously update a machine AI model;
a correction unit configured to apply the machine AI model to a digital map to identify and correct deviations; and
a storage unit configured to centrally store verified and digital maps.
